(19) United States
(12) Patent Application Publication
(10) Pub. No.: US 2006/0227328 A1
(43) Pub. Date: Oct. 12, 2006

(54) Light-sensing system that uses light guides

(76) Inventors: Gregory D. Vanwiggeren, San Jose, CA (US); Rene P. Helbing, Palo Alto, CA (US); Daniel B. Roitman, Palo Alto, CA (US)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 11/101,848

(22) Filed: Apr. 8, 2005

(51) Int. Cl. G01N 21/55

(52) U.S. Cl. 356/445

(57) ABSTRACT

Light-sensing systems and methods thereof are described. A light source illuminates target areas arrayed on a surface. Light guides receive light reflected from the target areas. The amount of light reflected from a target area corresponds at least in part to the composition of a substance associated with that target area. Detectors receive reflected light carried by the light guides.

### TECHNICAL FIELD

Embodiments in accordance with the invention pertain to light sensors.

### BACKGROUND ART

In surface plasmon resonance (SPR) spectroscopy, light from a light source is directed onto a metal film and the intensity of the light reflected from the metal film is measured. The intensity of light reflected from the metal film depends on the angle of incidence or the wavelength of light from the light source, and also depends on the refractive index of a substance on the side of the metal film that is opposite the side facing the light source.

SPR can be used to perform highly sensitive measurements of chemical and biological substances. For example, SPR can be used to measure interactions between proteins. A first protein (e.g., a ligand) is attached to the metal film on the side of the film not facing the light source, and a second protein (e.g., an analyte) is placed in solution and flowed over the first protein. If the first and second proteins bind to some degree, a composition of the first and second proteins is formed on the surface of the metal film away from the light source. The refractive index of the composition depends on the relative amounts of the first and second proteins, and will vary with time if the relative amounts of the first and second proteins change with time. The metal film is illuminated with light at different wavelengths or different angles of incidence. By measuring the intensity of the reflected light at those different angles of incidence or wavelengths, the amount of binding can be derived. The measurements can be repeated so that the amount of binding as a function of time can be plotted. Association and dissociation rates for the two proteins can be determined in this manner. These rates are of key interest in the field of drug discovery, for example.

Multiple experiments can be conducted at the same time by arraying a number of samples on the surface of the metal film. For example, different types of ligands can be tested at the same time to measure binding affinity with a particular analyte. Light reflected from the samples can be imaged using a camera. In essence, the camera takes pictures of the array of samples at a frequency that corresponds to the frame rate of the camera. The images are then processed to measure the intensity of light reflected from each sample versus time.

A camera used for SPR may use an imager consisting of a 320×256 array of pixels. For each image frame, the digital values of the pixels (e.g., 81,920 pixel values for a 320×256 array of pixels) are transferred to a computer system for processing. For each sample tested, the pixel values that correspond to that sample are extracted from the other values. The pixel values extracted for a sample are then averaged to provide a data point for that sample.

It is desirable to increase the number of samples that can be tested at a time, so that testing can be completed more efficiently. It is also desirable to increase the rate at which data is collected, allowing information about the interaction between substances (e.g., proteins) to be captured in more detail. The data collection rate can be increased by increasing the rate at which the samples are imaged. This can be achieved using a camera capable of operating at higher frame rates.

However, increasing the number of samples and the frame rate increases the amount of data that needs to be transferred and processed. Tests may be conducted over a period of days, so a tremendous amount of data can be collected, placing a heavy burden on the resources used to transfer and process the data. Additional computational resources can be used to alleviate data handling and processing loads, but that can increase the cost of testing.

Also, cameras that operate at higher frame rates are quite expensive. For example, a camera that operates at 60 frames per second (fps) may cost around $20,000, while a camera that operates at 400 fps may cost around $50,000. Cameras can have other shortcomings as well. For example, cameras have a limited full well capacity (that is, they can only store a limited number of electrons per pixel before becoming saturated). Also, cameras have a relatively low quantum efficiency (the rate at which photons are converted to electrons) of less than 20 percent.

### SUMMARY

Accordingly, a system and/or method that can be used with a sufficiently large number of samples and that can permit higher data collection rates, without substantially increasing either cost or data handling and processing loads, would be valuable.

Embodiments in accordance with the invention pertain to light-sensing systems and methods thereof. In one embodiment, a light source illuminates target areas arrayed on a surface. Light guides receive light reflected from the target areas. The amount of light reflected from a target area corresponds at least in part to the composition of a substance associated with that target area. Detectors receive reflected light carried by the light guides.

### BRIEF DESCRIPTION OF THE DRAWINGS

The accompanying drawings, which are incorporated in and form a part of this specification, illustrate embodiments of the invention and, together with the description, serve to explain the principles of the invention. The drawings referred to in this description should not be understood as being drawn to scale except if specifically noted.

FIG. 1 illustrates one embodiment of a light-sensing system in accordance with the invention.

FIG. 2 illustrates sample areas arrayed on a surface in one embodiment in accordance with the invention.

FIG. 3 illustrates a second embodiment of a light-sensing system in accordance with the invention.

FIG. 4 illustrates a third embodiment of a light-sensing system in accordance with the invention.

FIG. 5 illustrates a fourth embodiment of a light-sensing system in accordance with the invention.

FIG. 6 illustrates a fifth embodiment of a light-sensing system in accordance with the invention.

FIG. 7 illustrates a sixth embodiment of a light-sensing system in accordance with the invention.

FIG. 8 illustrates a seventh embodiment of a light-sensing system in accordance with the invention.

FIG. 9 is a flowchart of one embodiment of a method of sensing reflected light in accordance with the invention.

### DETAILED DESCRIPTION OF THE INVENTION

Reference will now be made in detail to various embodiments in accordance with the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. In other instances, well known methods, procedures, components, and circuits have not been described in detail as not to unnecessarily obscure aspects of the invention.

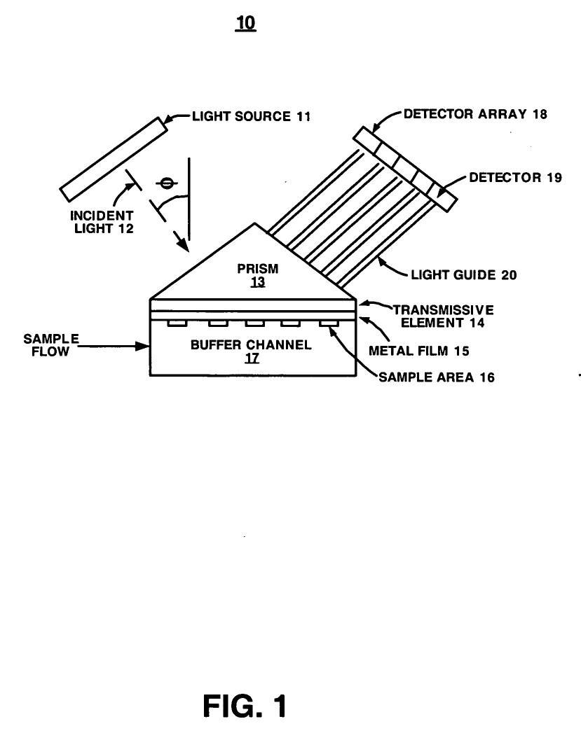

FIG. 1 illustrates a light-sensing system 10 in one embodiment in accordance with the invention. In one embodiment, system 10 is used for surface plasmon resonance (SPR) spectroscopy. In the present embodiment, system 10 includes light source 11, optically transmissive elements 13 and 14, metal film 15, detector array 18, exemplary detector 19, and light guides (exemplified by light guide 20) between metal film 15 and detector array 18.

Optically transmissive element (e.g., prism) 13 is made up of a transparent material. In the example of FIG. 1, and in other examples herein, optically transmissive element 13 is illustrated as being roughly triangular-shaped (in cross-section); however, the present invention is not so limited. In general, optically transmissive element 13 has a higher index of refraction than air, and as such it functions to increase the momentum of incident light 12 to match the momentum of the light to the momentum of a plasmon wave created in the metal film 15.

In one embodiment, optically transmissive element 14 is a transparent plate or slide that supports the metal film 15. Metal film 15 may be embodied as a coating that is applied to optically transmissive element 14. In one embodiment, metal film 15 is a thin film of gold; silver can also be used.

Coupled to the surface of the metal film 15, on the side of the film facing away from light source 11, are sample areas exemplified by sample area 16. In the present embodiment, sample area 16 and the other sample areas identify the positions at which ligands can be placed. Different ligands may be used in different sample areas. One or more types of analytes can be presented to the ligands in buffer chamber 17. In one embodiment, an analyte is placed in solution and flowed through buffer chamber 17 over the sample areas.

Light source 11 can be an ordinary light source with suitable filters and collimators. Alternatively, light source 11 can be a laser or a superluminescent light emitting diode (SLD). Other types of light sources may be used.

Also, multiple light sources may be used, with each light source placing a beam of light on each area of the surface of metal film 15 that corresponds to a respective sample area (e.g., there may be one light source per sample area). Alternatively, a diffractive plate can be placed between light source 11 and the sample areas, so that the light from the light source is split into multiple beams of light, each beam of light illuminating an area on the surface of metal film 15 that corresponds to a respective sample area.

In one embodiment, the wavelength of light emitted by light source 11 can be varied. In another embodiment, light source 11 can be moved so that the angle of incidence θ (the angle formed by incident light 12 and a vector that is normal to the plane of metal film 15) can be varied.

Light source 11 transmits light 12 onto and through optically transmissive elements 13 and 14 to metal film 15. In the embodiment of FIG. 1, light reflected from metal film 15 is carried by a number of light guides (exemplified by light guide 20) to detector array 18, which includes a number of detectors exemplified by detector 19.

In one embodiment, detector array 18 is a linear array. In one embodiment, a V-groove assembly with a pitch that corresponds to the pitch of the detectors in detector array 18 is used to align the light guides with the detectors. In one embodiment, the detectors (e.g., detector 19) are photodiodes. In one embodiment, the light guides (e.g., light guide 20) are optical fibers. The use of a system such as system 10 instead of a system that uses a camera, for example, can result in significant cost savings because the cost of a detector array may be orders of magnitude less than the cost of a suitable camera. As will be discussed further below, embodiments in accordance with the invention provide other advantages as well.

The number of light guides generally corresponds to the number of sample areas, and the number of detectors generally corresponds to the number of light guides; however, the invention is not so limited. In one embodiment, each light guide is associated with a single sample area, and each detector in detector array 18 is associated with a single light guide (and hence with a single sample area). In such an embodiment, the light reflected from the area of metal film 15 that corresponds to sample area 16 will be captured by light guide 20, and carried by light guide 20 to detector 19, for example. Light reflected from other areas on metal film 15, corresponding to other sample areas, will be similarly captured by a corresponding light guide and carried to a respective detector.

The light guides can be placed sufficiently close to metal film 15 so that the light reflected from an area on metal film 15 can be coupled into a respective light guide without significant crosstalk with light reflected from other areas. For example, the light guides can be pressed against or nearly against optically transmissive element 13.

In one embodiment, the cross-sectional area of a light guide (e.g., light guide 20) is not more than the size of a sample area (e.g., sample area 16). More precisely, the cross-sectional area of a light guide is less than the size of the area on metal film 15 from which light associated with a particular sample area is reflected. In general, a light guide is sized and positioned so that it does not capture light reflected from outside a defined area on metal film 15. For example, light guide 20 is sized and positioned so that it does not capture light reflected from metal film 15 outside of the area on metal film 15 associated with sample area 16.

System 10 is now described in operation for SPR spectroscopy. Ligands are coupled to metal film 15 (e.g., at sample area 16). An analyte solution is flowed past sample area 16 in buffer channel 17. Light from light source 11 is incident on metal film 15, having passed through optically transmissive elements 13 and 14. Light reflected from the area on metal film 15 that corresponds to sample area 16 is coupled into light guide 20. Light carried by light guide 20 is received at detector 19. This process continues over time until the test is completed.

The amount of light reflected from metal film 15 is a function of the refractive index of the substance at sample area 16 and the wavelength or angle of incidence of the incident light 12. The refractive index of the substance at sample area 16 is in turn a function of the degree to which the ligand and the analyte interact (e.g., the degree to which the analyte and the ligand bind). The angle of incidence θ or the wavelength of the incident light 12 can be varied to produce a condition that resonates the free electrons at the reflecting surface of metal film 15. At the SPR condition, the intensity or amount of light reflected by metal film 15 is decreased. The amount of reflected light received at detector 19, along with the angle of incidence or the wavelength of the incident light 12, can be used to determine the amount of interaction between the ligand and the analyte at sample area 16. System 10 functions in a similar manner with regard to the other sample areas, light guides and detectors.

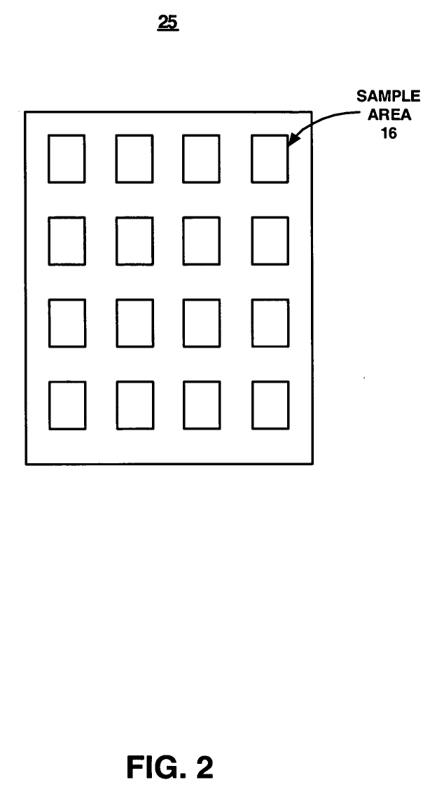

FIG. 2 illustrates a number of sample areas, including sample area 16, arrayed on a chip or substrate 25 in one embodiment in accordance with the invention. Different numbers of sample areas, perhaps arranged differently than shown in FIG. 2, can be used. In one embodiment, with reference also to FIG. 1, chip 25 is mounted to the surface of metal film 15 that faces away from light source 11. In one embodiment, a light guide and a detector are associated with each of the sample areas in chip 25. Thus, for example, a 4-by-4 array of samples can be coupled to a 16-element detector array (e.g., a linear array of 16 detectors). Additional detector arrays can be used if the number of samples is greater than the number of detectors in a single array.

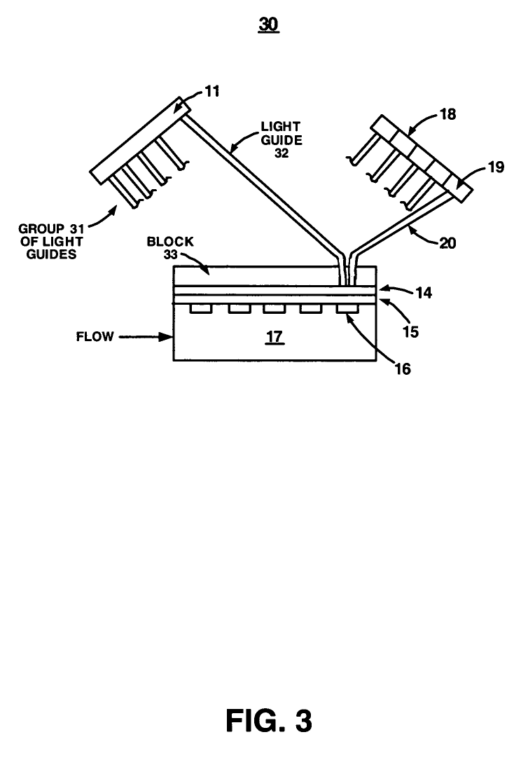

FIG. 3 illustrates a light-sensing system 30 in one embodiment in accordance with the invention. In one embodiment, system 30 is used for SPR spectroscopy.

In the present embodiment, system 30 includes light source 11, optically transmissive element (e.g., slide or plate) 14, metal film 15, detector array 18, exemplary detector 19, and light guides (exemplified by light guide 20) between metal film 15 and detector array 18, previously described herein.

System 30 also incorporates a group 31 of light guides (exemplified by light guide 32) that carry light from light source 11 to the sample areas. In one embodiment, the light guides are optical fibers. The light guides in the group 31 can be pressed against or nearly against the areas on metal film 15 that correspond to the sample areas. In an SPR application, a collimator can be placed between the light guides and the metal film 15.

The light guides that receive reflected light (e.g., light guide 20) can also be pressed against or nearly against areas of metal film 15 corresponding to the sample areas. In one embodiment, a block 33 (e.g., a plastic block) can be used to hold the light guides that deliver light to metal film 15 and the light guides that receive light reflected from metal film 15 in place relative to the areas on metal film 15 that correspond to the sample areas. The group 31 of light guides can be moved within block 33 so that the angle of incidence of the incident light can be varied.

The number of light guides in the group 31 of light guides generally corresponds to the number of sample areas; however, the invention is not so limited. In one embodiment, each of the light guides in the group 31 of light guides is associated with a single sample area. For example, light guide 32 is associated with sample area 16.

In another embodiment, in place of block 33, an optically transmissive element 13 (FIG. 1) can be interposed between the group 31 of light guides and the metal film 15, and as such also between the metal film 15 and the light guides that receive reflected light (exemplified by light guide 20). In such an embodiment, the incident light guides (e.g., light guide 32) and the light guides that receive reflected light (e.g., light guide 20) can be pressed against or nearly against the optically transmissive element 13.

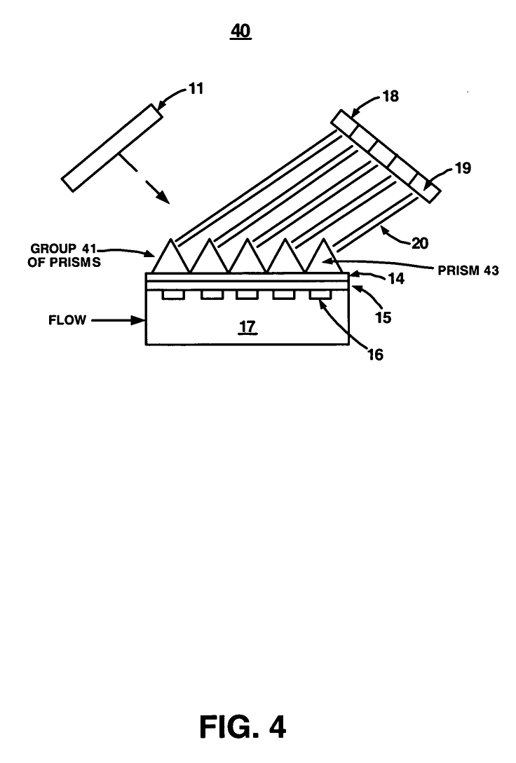

FIG. 4 illustrates a light-sensing system 40 in one embodiment in accordance with the invention. In one embodiment, system 40 is used for SPR spectroscopy.

In the present embodiment, system 40 includes light source 11, optically transmissive element (e.g., slide or plate) 14, metal film 15, detector array 18, exemplary detector 19, and light guides (exemplified by light guide 20) between metal film 15 and detector array 18, previously described herein. System 40 also includes a group 41 of optically transmissive elements (exemplified by prism 43) composed of a transparent material. In general, the number of elements in the group 41 corresponds to the number of sample areas; however, the invention is not so limited. In one embodiment, each of the optically transmissive elements in the group 41 is associated with a single sample area. For example, prism 43 may be associated only with sample area 16.

The optically transmissive elements (e.g., prism 43) in the group 41 are smaller than optically transmissive element 13 of FIG. 1, and so the light guides (exemplified by light guide 20) can be placed closer to metal film 15. For example, light guide 20 can be pressed against or nearly against prism 43.

In one embodiment, each light guide is associated with a single optically transmissive element in the group 41 of optically transmissive elements. For example, light guide 20 may be associated only with prism 43.

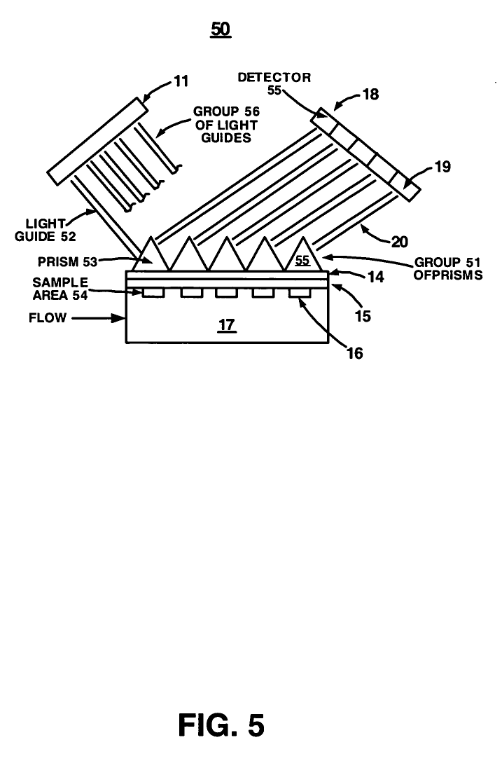

FIG. 5 illustrates a light-sensing system 50 in one embodiment in accordance with the invention. In one embodiment, system 50 is used for SPR spectroscopy.

In the present embodiment, system 50 includes light source 11, optically transmissive element (e.g., slide or plate) 14, metal film 15, detector array 18, exemplary detector 19, and light guides (exemplified by light guide 20) between metal film 15 and detector array 18, previously described herein.

System 50 also includes a group 51 of optically transmissive elements (exemplified by prisms 53 and 55) composed of a transparent material. In general, the number of these elements corresponds to the number of sample areas; however, the invention is not so limited. In one embodiment, each of the optically transmissive elements in the group 51 is associated with a single sample area. For example, prism 53 may be associated only with sample area 54, and prism 55 may be associated only with sample area 16.

System 50 also includes a group 56 of light guides (exemplified by light guide 52) that carry light from light source 11 to the optically transmissive elements (exemplified by prism 53). In one embodiment, these light guides are optical fibers. The light guides in the group 56 can be pressed against or nearly against the optically transmissive elements in the group 51. For example, light guide 52 can be pressed against or nearly against prism 53. In one embodiment, each of the light guides in the group 56 is associated with a single optically transmissive element in the group 51. That is, for example, light guide 52 may be associated only with prism 53. In an SPR application, a collimator can be placed between the light guides and the group 51 of optically transmissive elements.

The light guides (exemplified by light guide 20) that carry light reflected from metal film 15 can also be placed closer to metal film 15. For example, light guide 20 can be pressed against or nearly against prism 55.

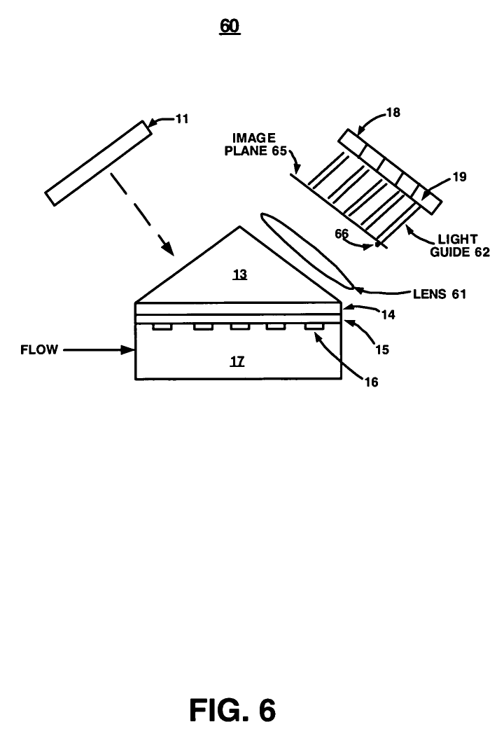

FIG. 6 illustrates a light-sensing system 60 in one embodiment in accordance with the invention. In one embodiment, system 60 is used for SPR spectroscopy.

In the present embodiment, system 60 includes light source 11, optically transmissive element (e.g., prism) 13, optically transmissive element (e.g., slide or plate) 14, metal film 15, detector array 18, and detector 19, previously described herein.

System 60 also includes a number of light guides (exemplified by light guide 62) coupled to the detector array 18. The number of lights guides generally corresponds to the number of sample areas, and the number of detectors generally corresponds to the number of light guides; however, the invention is not so limited. In one embodiment, each light guide is associated with a single sample area, and each detector in detector array 18 is associated with a single light guide (and hence with a single sample area), as previously described herein.

In contrast to the embodiment of FIG. 1, for example, the light guides (e.g., light guide 62) do not extend up against or nearly up against the optically transmissive element 13. Instead, in one embodiment, an imaging lens 61 is interposed between the light guides (e.g., light guide 62) and the metal film 15, so that the ends of the light guides fall in the image plane (indicated as plane 65) of the imaging lens 61. In another embodiment, a diffractive optical element can be used in place of imaging lens 61.

In the embodiment of FIG. 6, light reflected from the metal film 15 passes through imaging lens 61. Imaging lens 61 in essence maps a position in the sensor plane into a position in the imaging plane 65. For example, light reflected from the area of metal film 15 that corresponds to sample area 16 is reflected to lens 61, which maps that light to a position 66 in the image plane 65. Light guide 62 is positioned at the image plane 65 at the point 66 to receive light reflected from the area of metal film 15 that corresponds to sample area 16. The light carried by light guide 62 is received at detector 19.

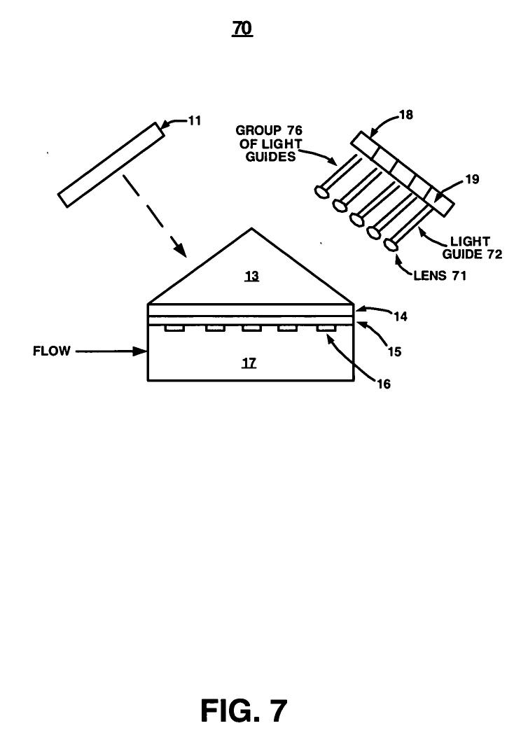

FIG. 7 illustrates a light-sensing system 70 in one embodiment in accordance with the invention. In one embodiment, system 70 is used for SPR spectroscopy.

In the present embodiment, system 70 includes light source 11, optically transmissive element (e.g., prism) 13, optically transmissive element (e.g., slide or plate) 14, metal film 15, detector array 18, and detector 19, previously described herein.

System 70 also includes a group 76 of light guides (exemplified by light guide 72) coupled to the detector array 18. The number of lights guides generally corresponds to the number of sample areas, and the number of detectors generally corresponds to the number of light guides; however, the invention is not so limited. In one embodiment, each light guide is associated with a single sample area, and each detector in detector array 18 is associated with a single light guide (and hence with a single sample area), as previously described herein.

Similar to the embodiment of FIG. 6, for example, the group 76 of light guides (e.g., light guide 72) do not extend up against or nearly up against the optically transmissive element 13. In contrast to the embodiment of FIG. 6, a lens 71 is coupled to the end of each of the light guides. For example, lens 71 is coupled to the end of light guide 72.

In one embodiment, an imaging lens 61 is positioned so that light reflected from metal film 15 passes through lens 61 before reaching the group 76 of light guides. In such an embodiment, the group 76 of light guides are situated within the image plane of lens 61.

In the embodiment of FIG. 7, light reflected from the metal film 15 passes through imaging lens 61. Imaging lens 61 in essence maps a position in the sensor plane into a position in the image plane of lens 61. For example, light reflected from the area of metal film 15 that corresponds to sample area 16 is reflected to lens 61, which maps that light to a position in the image plane 65 that corresponds to the position of lens 71, which couples that reflected light to light guide 72. The light carried by light guide 72 is received at detector 19.

In another embodiment, diffractive optical elements can be used instead of lenses such as lens 71. An array of micro-lenses can be formed on a sheet of plastic, for example, and positioned up against or nearly up against the group 76 of light guides, such that each light guide is aligned with a respective micro-lens.

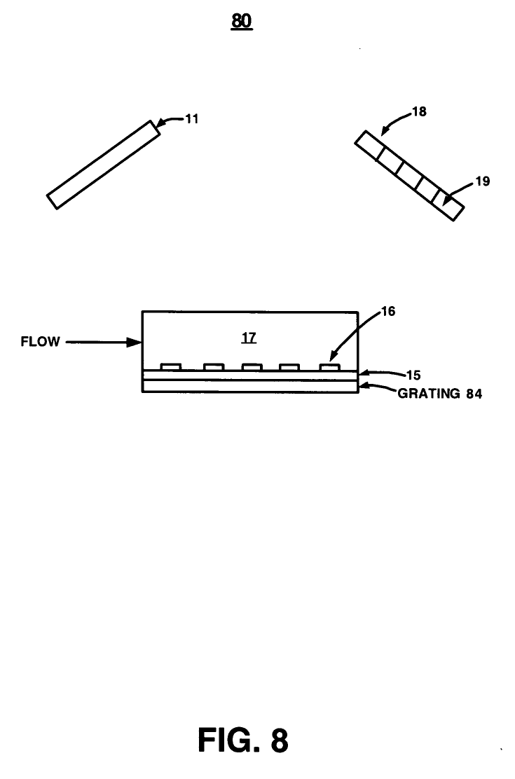

FIG. 8 illustrates a light-sensing system 80 in one embodiment in accordance with the invention. In one embodiment, system 80 is used for SPR spectroscopy.

In the present embodiment, system 80 includes light source 11, metal film 15, detector array 18, and detector 19, previously described herein. System 80 also includes a grating 84 to match the momentum of the light to the momentum of a plasmon wave created in the metal film 15. In one embodiment, grating 84 provides support for metal film 15. In such an embodiment, metal film 15 follows the contours of grating 84. Light passes through the film 15 to the grating 84.

The features of system 80 can be combined with the other features described above. That is, FIGS. 1 and 3-7 describe various features for delivering light from a light source to a surface and various features for capturing light reflected from the surface. Those light-delivery and light-capture features can also be used with the embodiments described in conjunction with FIG. 8. In particular, use of a grating such as grating 84, for example, allows light guides used for delivering light to the surface, or for capturing light reflected from the surface, to be placed against or nearly against the areas of the surface that correspond to the sample areas (e.g., sample area 16).

Also, for example, the features described in conjunction with FIGS. 1 and 3 can be combined, or the features described in conjunction with FIG. 6 or 7 can be combined with the features described in conjunction with FIG. 3, 4 or 5. In general, the features of each of the various embodiments described above can be used alone or appropriately combined with the features from one or more other embodiments.

In addition to the cost savings mentioned above, embodiments in accordance with the invention provide a number of other advantages. For one, samples can be collected at a faster rate; that is, the sample rate is not limited by frame rate. Sample rates as high as five mega-samples per second are achievable. Thus, more time-wise continuous plots of test results can be generated.

Also, a single data point (e.g., the detector output) is collected for each sample area, eliminating the transfer of large amounts of data for processing. This also eliminates the extraction and averaging of pixel values for each of the samples tested, simplifying processing.

Furthermore, detectors (e.g., photodiodes) are more precise than cameras, measured in terms of the number of output bits. Also, cameras have limited full well capacity and may saturate if too much light is placed on the sample areas. Detectors are not subject to these limitations, in particular for the levels of light used in applications such as SPR.

In addition, the quantum efficiency of detectors (e.g., photodiodes) is on the order of 75 percent, which is greater than the quantum efficiency of cameras. Thus, for a given amount of light, a detector will output a better signal than a camera.

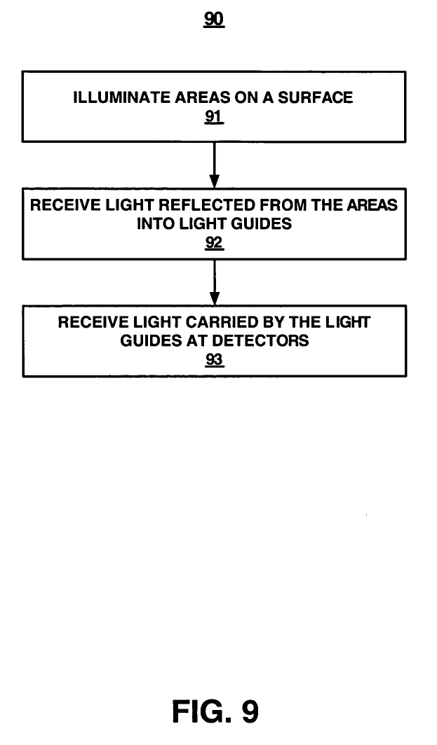

FIG. 9 is a flowchart 90 of a method of sensing light reflected from a surface in one embodiment in accordance with the invention. In step 91, a plurality of areas on the surface (e.g., metal film 15 of FIG. 1) are illuminated by a light source. The areas on the surface correspond to an arrangement of sample areas (e.g., sample area 16). In one embodiment, the sample areas are present on the side of the surface not facing the light source (e.g., as in FIGS. 1 and 3-7); in another embodiment, the sample areas are on the side of the surface facing the light source (e.g., as in FIG. 8).

In one embodiment, light is transmitted to an area on the surface through an element (e.g., optically transmissive element 13 of FIG. 1) that increases the momentum of the light. In another embodiment, there is a plurality of such elements (exemplified by prism 43 of FIG. 4), where each of the elements is associated with a single area on the surface. In yet another embodiment, there is a grating (e.g., grating 84 of FIG. 8) that matches the momentum of light to the momentum of a plasmon wave.

In yet another embodiment, the light is transmitted to the surface via a plurality of light guides (e.g., light guide 32 of FIG. 3).

In step 92 of FIG. 9, the light reflected from areas on the surface is received into a plurality of light guides (e.g., light guide 20 of FIG. 1). In one embodiment, the reflected light passes through a lens (e.g., lens 61 of FIG. 6) before reaching a light guide. In one such embodiment, a lens is coupled to each of the light guides (e.g., lens 71 is coupled to light guide 72 of FIG. 7). In another embodiment, a diffractive optical element or an array of diffractive optical elements can be used instead of the lens or lenses.

In step 93 of FIG. 9, light carried by the light guides is received at a plurality of detectors (e.g., detector array 18 of FIG. 1). In an SPR embodiment, the amount of reflected light received at the detectors is used to determine an amount of interaction between a ligand and an analyte that are presented to each other below the reflecting surface.

The invention is thus described in various embodiments. While the invention has been described in particular embodiments, it should be appreciated that the present invention should not be construed as limited by such embodiments, but rather construed according to the following claims.

What is claimed is:

1. A system for surface plasmon resonance spectroscopy, said system comprising:
a light source that illuminates target areas arrayed on a surface;
a first plurality of light guides that receive light reflected from corresponding target areas, wherein the amount of light reflected from a target area corresponds at least in part to the composition of a substance associated with said target area; and
a plurality of detectors that receive reflected light carried by said light guides.

2. The system of claim 1 wherein each of said light guides is associated with a single target area.

3. The system of claim 1 wherein each of said detectors is associated with a single one of said light guides.

4. The system of claim 1 further comprising a lens disposed so that light reflected from said surface passes through said lens to said light guides.

5. The system of claim 1 further comprising a plurality of lenses, each of said lenses coupled to an end of a respective light guide, wherein light reflected from said surface passes through said lenses to said light guides.

6. The system of claim 1 further comprising a diffractive optical element disposed so that light reflected from said surface passes through said diffractive optical element to said light guides.

7. The system of claim 1 wherein said target areas on said surface are larger than the cross-sections of said light guides.

8. The system of claim 1 further comprising a second plurality of light guides that carry light from said light source to said target areas on said surface.

9. The system of claim 1 further comprising an element that increases the momentum of said light.

10. The system of claim 1 further comprising a plurality of elements disposed between said light source and said target areas on said surface so that light passes through said elements to said target areas, said elements increasing the momentum of said light, wherein each of said elements is associated with a single area on said surface.

11. A method of sensing light reflected from a surface, said method comprising:
illuminating a plurality of target areas arrayed on said surface, said target areas corresponding to an array of samples;
receiving reflected light from said target areas into a first plurality of light guides, wherein the intensity of said reflected light is affected by the refractive index of said samples; and
receiving light carried by said light guides at a plurality of detectors.

12. The method of claim 11 wherein each of said light guides is associated with a single target area.

13. The method of claim 11 wherein each of said detectors is associated with a single one of said light guides.

14. The method of claim 11 wherein said illuminating comprises transmitting light to an area on said surface through a plurality of elements that increase the momentum of said light, wherein each of said elements is associated with a single area on said surface.

15. The method of claim 11 wherein said illuminating comprises transmitting light to said areas via a second plurality of light guides.

16. The method of claim 11 wherein light reflected from an area on said surface passes through a lens before reaching a light guide.

17. The method of claim 11 wherein light reflected from an area on said surface passes through a diffractive optical element before reaching a light guide.

18. The method of claim 11 further comprising varying the wavelength of light that illuminates said areas.

19. The method of claim 11 further comprising varying the angle of incidence of light that illuminates said areas.

20. An apparatus for surface plasmon resonance (SPR) spectroscopy, said apparatus comprising:
a light source;
a surface coupled to an arrangement of samples;
a first plurality of optical fibers, wherein light from said light source is reflected to said first plurality of optical fibers from areas on said surface that correspond to positions of said samples, wherein the amount of light reflected from a target area is reduced at an SPR condition; and
an array of detectors that receive light carried by said first plurality of optical fibers.

21. The apparatus of claim 20 wherein an optical fiber of said first plurality of optical fibers receives reflected light that corresponds to a single sample of said arrangement of samples and wherein a detector of said array of detectors receives light from a single optical fiber of said first plurality of optical fibers

22. The apparatus of claim 20 further comprising a second plurality of optical fibers that carry light from said light source to said surface.

23. The apparatus of claim 20 further comprising an element that increases the momentum of light from said light source.

24. The apparatus of claim 20 further comprising a plurality of optically transmissive elements disposed between said light source and said surface, said elements increasing the momentum of light from said light source, wherein one of said elements is associated with a single sample.

25. The apparatus of claim 20 further comprising a lens disposed between said surface and said optical fibers.

26. The apparatus of claim 20 further comprising a plurality of lenses disposed between said surface and said optical fibers, wherein a lens is associated with a single optical fiber.

27. The apparatus of claim 20 further comprising a diffractive optical element disposed between said surface and said optical fibers.

28. The apparatus of claim 20 further comprising an array of diffractive optical elements disposed between said surface and said optical fibers, wherein a diffractive optical element is associated with a single optical fiber.
